(19) United States
(12) Patent Application Publication
(10) Pub. No.: US 2025/0372009 A1
(43) Pub. Date: Dec. 4, 2025

(54) Electronic Devices with Ambient-Adaptive Three-Dimensional Displays

(71) Applicant: Apple Inc., Cupertino, CA (US)

(72) Inventors: Sikandar Yusufoddin Mashayak, San Jose, CA (US); Shaobo Guan, San Carlos, CA (US); Gilles M. Cadet, Agoura Hills, CA (US); Graham L. Fyffe, Playa Vista, CA (US)

(21) Appl. No.: 18/948,230

(22) Filed: Nov. 14, 2024

Related U.S. Application Data
(60) Provisional application No. 63/655,809, filed on Jun. 4, 2024.

(51) Int. Cl. G09G 3/00; H04N 9/77

(52) U.S. Cl. CPC G09G 3/003; H04N 9/77; G09G 2320/0626; G09G 2320/0666; G09G 2354/00; G09G 2360/144

(57) ABSTRACT

A head-mounted device may have an inner display that displays images for a user and an outer display that informs nearby people of the status of the user and inner display. For example, the outer display may display an image of a face, an abstract layer, or both, depending on whether the inner display is operating in passthrough mode, mixed reality mode, or virtual reality mode. An ambient light sensor and one or more cameras in the head-mounted device may be used to measure the brightness and color of ambient light. Ambient light mapping circuitry may generate a spatial ambient light map using the ambient light sensor and camera data. The color of the face layer on the outer display may be adapted based on the spatial ambient light map.

This application claims the benefit of U.S. provisional patent application No. 63/655,809, filed Jun. 4, 2024, which is hereby incorporated by reference herein in its entirety.

### FIELD

This relates generally to electronic devices including electronic devices with input-output components.

### BACKGROUND

Electronic devices sometimes include optical components. For example, a wearable electronic device such as a head-mounted device may include a display for displaying an image.

Conventional head-mounted devices tend to isolate users from their surroundings. As a result, interactions between a user that is wearing a head-mounted device and people in the user's environment may be extremely limited or non-existent. For example, there is often no way for a person standing next to a user wearing a head-mounted device to discern the user's emotions or to recognize the identity of the user.

### SUMMARY

A head-mounted device may include a housing, an outward-facing ambient light sensor coupled to the housing, at least one outward-facing color camera coupled to the housing, at least one outward-facing monochrome camera coupled to the housing, at least one inward-facing display coupled to the housing, and an outward-facing three-dimensional display coupled to the housing that is configured to display an image using a spatial ambient light map that is based on sensor data from the outward-facing ambient light sensor, the at least one outward-facing color camera, and the at least one outward-facing monochrome camera.

A method of operating a head-mounted device with a three-dimensional display, at least one inward-facing camera, at least one outward-facing camera, and an ambient light sensor may include obtaining one or more enrollment images of target content, determining ambient light information using the at least one outward-facing camera and the ambient light sensor, obtaining a real time image of the target content using the at least one inward-facing camera, generating an image of the target content based on the one or more enrollment images of the target content, the ambient light information, and the real time image of the target content, and mapping the image to the three-dimensional display.

A method of operating an electronic device with a three-dimensional display where each pixel in the three-dimensional display is configured to emit light in a given direction, a plurality of cameras, and an ambient light sensor may include obtaining sensor data using the plurality of cameras and the ambient light sensor, generating, based on the sensor data, an ambient light map that represents ambient light in a physical environment of the electronic device, and displaying content on the three-dimensional display. Each pixel in the three-dimensional display may be color corrected based on the ambient light map and the given direction associated with that pixel.

### BRIEF DESCRIPTION OF THE DRAWINGS

FIG. 1 is a top view of an illustrative electronic device such as a head-mounted device in accordance with some embodiments.

FIG. 2A is a front view of an illustrative electronic device with an area for a front-facing display, an ambient light sensor, and cameras in accordance with some embodiments.

FIG. 2B is a side view of the illustrative electronic device of FIG. 2A in accordance with some embodiments.

FIG. 2C is a top view of the illustrative electronic device of FIG. 2A in accordance with some embodiments.

FIG. 3 is a front view of an illustrative electronic device with a front-facing display displaying content such as a face when an inner display in the electronic device is operating in a passthrough display mode in accordance with some embodiments.

FIG. 4 is a front view of an illustrative electronic device with a front-facing display displaying content such as a face overlaid with an abstract layer when an inner display in the electronic device is operating in a mixed reality display mode in accordance with some embodiments.

FIG. 5 is a front view of an illustrative electronic device with a front-facing display displaying content such as an abstract layer when an inner display in the electronic device is operating in a virtual reality display mode in accordance with some embodiments.

FIG. 6 is a front view of an illustrative electronic device with a front-facing display displaying content such as user interface elements in accordance with some embodiments.

FIG. 7 is a chromaticity diagram illustrating how the white point of a display such as the outer display of FIGS. 1-6 may be adjusted based on the color of ambient light in accordance with some embodiments.

FIG. 8 is a diagram of illustrative ambient light mapping circuitry that may be used to generate a spatial ambient light map based on ambient light sensor data and camera data in accordance with some embodiments.

FIG. 9 is a diagram of an illustrative spatial ambient light map in accordance with some embodiments.

FIG. 10 is a cross-sectional side view of an illustrative lenticular display that provides images to a viewer in accordance with some embodiments.

FIG. 11 is a top view of an illustrative lenticular lens film showing the elongated shape of the lenticular lenses in accordance with some embodiments.

FIGS. 12A-12C are perspective views of illustrative three-dimensional content that may be displayed by a three-dimensional display in accordance with some embodiments.

FIG. 13 is a schematic diagram of an illustrative electronic device with display pipeline circuitry in accordance with some embodiments.

### DETAILED DESCRIPTION

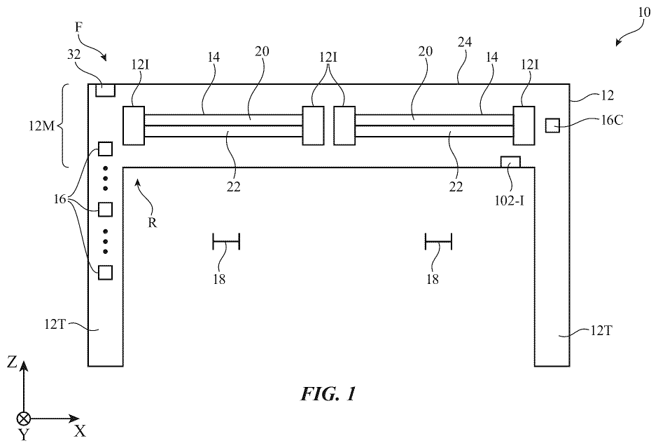

A top view of an illustrative head-mounted device is shown in FIG. 1. As shown in FIG. 1, head-mounted devices such as electronic device 10 may have head-mounted support structures such as housing 12. Housing 12 may include portion (e.g., support structures 12T) to allow device 10 to be worn on a user's head. A main housing portion (e.g., support structure 12M) and associated internal housing portion (e.g., internal support structures 12I) may support the display, lenses, and other optical components (e.g., structures 12I may serve as lens support structures).

Front face F of housing 12 may face outwardly away from a user's head. Rear face R of housing 12 may face the user. During operation, a user's eyes are placed in eye boxes 18. When the user's eyes are located in eye boxes 18, the user may view content being displayed by display 14 through associated lenses 22. Display 14 faces inwardly toward eye boxes 18 and may therefore sometimes be referred to as a rear-facing display, an inner display, an inwardly facing display, a display that is not publically viewable, or a private display. Front face F of device 10 faces away from eye boxes 18 and faces away from lenses 22.

In some configurations, optical components such as display 14 and lenses 22 are configured to display computer-generated content that is overlaid over real-world images (e.g., a user may view the real world through the optical components). In other configurations, which are sometimes described herein as an example, real-world light is blocked (e.g., by an opaque housing wall at front face F of housing 12 and/or other portions of device 10).

In addition to inwardly facing optical components such as inner display 14 and associated lenses 22 that allow a user with eyes in eye boxes 18 to view images, device 10 may have one or more displays and/or other light-emitting components (e.g., status indicator lights, illuminated button icons, etc.) that are located on exterior surfaces of device 10. Device 10 may, for example, have one or more external displays (sometimes referred to as outwardly facing displays or publically viewable displays) such as display 24 on front face F. Display 24 may present images that are viewable to people in the vicinity of the user while the user is wearing and while the user is using device 10 to view images on display 14. Display 24 may also be used to display images on the exterior of device 10 that are viewable by the user when device 10 is not being worn (e.g., when device 10 is resting in the user's hand or on a tabletop and is not on a user's head). Display 24 may be a touch sensitive display and/or may be a force sensitive display (e.g., display 24 or part of display 24 may overlap a finger sensor) or, if desired, display 24 may be insensitive to touch and force input. There may be one or more outwardly facing displays such as display 24 in device 10. Haptic output components may be overlapped by one or more of these outwardly facing displays or may be mounted elsewhere in housing 12 (e.g., to provide haptic output when a user supplies finger input such as touch input and/or force input to a portion of a display).

The support structures of device 10 may include adjustable components. For example, support structures 12T and 12M of housing 12 may include adjustable straps or other structures that may be adjusted to accommodate different head sizes. Support structures 12I may include motor-driven adjustable lens mounts, manually adjustable lens mounts, and other adjustable optical component support structures. Structures 12I may be adjusted by a user to adjust the locations of eye boxes 18 to accommodate different user interpupillary distances. For example, in a first configuration, structures 12I may place lenses and other optical components associated respectively with the user's left and right eyes in close proximity to each other so that eye boxes 18 are separated from each other by a first distance and, in a second configuration, structures 12I may be adjusted to place the lenses and other optical components associated with eye boxes 18 in a position in which eye boxes are separated from each other by a second distance that is larger than this distance.

In addition to optical components such as displays 14 and 24, device 10 may contain other electrical components 16. The electrical components of device 10 such as the displays and other electrical components 16 may include integrated circuits, discrete components, printed circuits, and other electrical circuitry. For example, these components may include control circuitry 16C and input-output devices.

Control circuitry 16C of device 10 may include storage and processing circuitry for controlling the operation of device 10. Control circuitry 16C may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 16C may be based on one or more microprocessors, microcontrollers, digital signal processors, baseband processors, power management units, audio chips, graphics processing units, application specific integrated circuits, and other integrated circuits. Software code may be stored on storage in control circuitry 16C and run on processing circuitry in control circuitry 16C to implement control operations for device 10 (e.g., data gathering operations, operations involving the adjustment of the components of device 10 using control signals, etc.). Control circuitry 16C in device 10 may include wired and wireless communications circuitry. For example, control circuitry 16C may include radio-frequency transceiver circuitry such as cellular telephone transceiver circuitry, wireless local area network (WiFi®) transceiver circuitry, millimeter wave transceiver circuitry, and/or other wireless communications circuitry.

Device 10 may be used in a system of multiple electronic devices. During operation, the communications circuitry of device 10 may be used to support communication between device 10 and other electronic devices in the system. For example, one electronic device may transmit video and/or audio data to device 10 or another electronic device in the system. Electronic devices in the system may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

The input-output devices of device 10 (e.g., input-output devices in components 16) may be used to allow a user to provide device 10 with user input. Input-output devices may also be used to gather information on the environment in which device 10 is operating. Output components in the input-output devices may allow device 10 to provide a user with output and may be used to communicate with external electrical equipment.

The input-output devices of device 10 may include one or more displays such as inner display 14 and external display 24. External display 24 may be formed from a liquid crystal display, organic light-emitting diode display, a display with an array of crystalline semiconductor light-emitting diode dies, or a display based on other types of pixels. In some configurations, a display in device 10 may include left and right display devices (e.g., display 14 may be formed from left and right components such as left and right scanning mirror display devices, liquid-crystal-on-silicon display devices, digital mirror devices, or other reflective display devices, left and right display panels based on light-emitting diode pixel arrays such as organic light-emitting display panels or display devices based on pixel arrays formed from crystalline semiconductor light-emitting diode dies, liquid crystal display devices panels, and/or or other left and right display devices in alignment with the user's left and right eyes, respectively). In other configurations, display 14 may include a single display panel that extends across both eyes or may use other arrangements in which content is provided with a single pixel array.

The display(s) of device 10 may be used to display visual content for a user of device 10. The content that is presented on display 14 may, for example, include virtual objects and other content that is provided to the display by control circuitry 16C and may sometimes be referred to as computer-generated content. An image on the display such as an image with computer-generated content may be displayed in the absence of real-world content or may be combined with real-world content. In some configurations, a real-world image may be captured by a camera (e.g., a forward-facing camera) so that computer-generated content may be electronically overlaid on portions of the real-world image (e.g., when device 10 is a pair of virtual reality goggles with an opaque display).

The input-output circuitry of device 10 may include sensors. The sensors may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source such as an infrared light source that emits one or more beams of light that are tracked using the image sensor after reflecting from a user's eyes), touch sensors, buttons, capacitive proximity sensors, light-based (optical) proximity sensors, other proximity sensors, force sensors such as strain gauges, capacitive force sensors, resistive force sensors and/or other force sensors configured to measure force input from a user's fingers or other external objects on a display, track pad, or other input surface, sensors such as contact sensors based on switches, gas sensors, pressure sensors, moisture sensors, magnetic sensors, audio sensors (microphones), ambient light sensors, light sensors that make user measurements, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), fingerprint sensors (e.g., two-dimensional capacitive fingerprint sensors, two-dimensional optical fingerprint sensors, etc.), and/or other sensors.

Sensors in device 10 may include an ambient light sensor such as ambient light sensor 32. Ambient light sensor 32 may be a color ambient light sensor having an array of detectors each of which is provided with a color filter. If desired, the detectors in ambient light sensor 32 may be provided with color filters of different respective colors. Information from the detectors may be used to measure the total amount of ambient light that is present in the vicinity of device 10. For example, the ambient light sensor may be used to determine whether device 10 is in a dark or bright environment. Based on this information, control circuitry 16C can adjust display brightness for display 14 and/or display 24 or can take other suitable action.

Color ambient light sensor 32 may be used to make ambient light intensity (e.g., brightness, illuminance, and/or luminance flux per unit area) measurements. Ambient light intensity measurements, which may sometimes be referred to as ambient light illuminance measurements, may be used by device 10 to adjust display brightness (as an example). Color ambient light sensors 32 may be used to make measurements of ambient light color (e.g., color coordinates, correlated color temperature, or other color parameters representing ambient light color). Control circuitry 16C may be used to convert these different types of color information to other formats, if desired (e.g., a set of red, green, and blue sensor output values may be converted into color chromaticity coordinates and/or may be processed to produce an associated correlated color temperature, etc.). As an example, ambient light sensor 32 may obtain X, Y, and Z values associated with an XYZ color space.

Color information and illuminance information from color ambient light sensor 32 can be used to adjust the operation of device 10. For example, the color cast (e.g., display white point) of display 14 and/or display 24 (e.g., the white point of display 14 and/or display 24) may be adjusted in accordance with the color of ambient lighting conditions. The white point of a display may be a correlated color temperature setting (e.g., measured in degrees Kelvin) that determines the warmth or coolness of displayed colors. If, for example, a user moves device 10 from a cool lighting environment (e.g., an outdoor blue sky environment) to a warm lighting environment (e.g., an incandescent light environment), the warmth of display 14 and/or display 24 may be increased accordingly, so that the user of device 10 does not perceive display 14 as being overly cold and/or so that people around the user wearing device 10 do not perceive display 24 as being overly cold. If desired, ambient light sensor 32 may include an infrared light sensor. In general, any suitable actions may be taken based on color measurements and/or total light intensity measurements (e.g., adjusting display brightness, adjusting display content, changing audio and/or video settings, adjusting sensor measurements from other sensors, adjusting which on-screen options are presented to a user of device 10, adjusting wireless circuitry settings, etc.).

To convey information about the user's emotions and other information about the user's appearance and thereby help connect the user to people around the user, display 24 and/or other output components may be used in conveying information about the user's state to people in the vicinity of the user. The information that is conveyed using publicly viewable display 24 and/or other output components may include information on the user's appearance such as information on the appearance of the user's eyes and/or other facial features, information on the user's physiological state (e.g., whether the user is perspiring, is under stress, etc.), information on the user's emotions (e.g. whether the user is calm, upset, happy, sad, etc.), and/or other information on the state of the user. The information may be conveyed visually (e.g., using display 24 and/or light-emitting components such as light-emitting diode status indicator lights, dedicated visual output devices such as devices that illuminate icons, text, one or more different eye-shaped symbols, etc. without using a full pixel array, etc.) and/or may be conveyed in other forms (e.g., using sound such as tones, synthesized voice, sound clips, etc.). Illustrative configurations for device 10 in which information on the state of the user is displayed visually using a publicly viewable display such as display 24 may sometimes be described herein as an example.

Because display 24 is publicly viewable, visual information displayed on display 24 can be used to convey information about the state of the user to people who can view display 24 (e.g., people in the vicinity of the user). These people might normally be able to interact with the user by virtue of observing the user's eyes and other facial features that are now being obscured by the presence of device 10. By placing appropriate information on display 24, control circuitry 16C can convey information about the user to others. The information may include text, graphics, and/or other images and may include still and/or moving content. The information that is displayed may be captured image data (e.g., captured images such as photographs and/or videos of facial features associated with the user) and/or may be computer-generated images (e.g., text, graphics such as user facial feature graphics, computer-processed photographs and/or videos, etc.). In some situations, information gathered by control circuitry 16C using input-output circuitry and/or wireless circuitry may be used in determining the content to be displayed on display 24.

The information displayed on display 24 may be real (e.g., a genuine facial expression) or may be artificial (e.g., a synthetic facial expression that does not represent a user's true facial expression). Configurations in which the images that are displayed on display 24 are representative of a user's true state help the user communicate with surrounding people. For example, if a user is happy, displaying a happy facial expression on display 24 will help the user convey the user's happy state to surrounding people. Configurations in which images that are displayed on display 24 are not representative of the user's true state may also be used to convey information to other people. If desired, a copy of the outwardly displayed facial expression or other publicly displayed information may be displayed on the user's private display (e.g., in a corner region of the display, etc.) so that the user is informed of the current outward appearance of device 10.

The use of display 24 may help a user convey information about the user's identity to other people. Consider, as an example, a scenario in which display 24 displays a photographic image of the user's facial features. The displayed facial features of the user may correspond to facial features captured in real time using an inwardly facing camera such as inward-facing camera 102-I and/or may correspond to previously captured facial feature images (still and/or moving). By filling in portions of the user's facial features that are otherwise obscured due to the presence of device 10, display 24 may help people in the vicinity of the user recognize the identity and facial expressions of the user.

Facial features may be displayed using a 1:1 replication arrangement. For example, control circuitry 16C may use display 24 to display an image of the portion of the user's face that is covered by display 24 without magnification or demagnification. Perspective correction may be applied to displayed images so that an image that is displayed on display 24 slightly in front of the surface of the user's face (e.g., 1-10 cm in front) will appear as if it is located directly at the surface of the user's face. In other situations, processed and/or synthesized content may be displayed on display 24. For example, display 24 may be used to display user facial feature graphics (graphical representations of the facial features of a user of device 10) such as computer-generated eyes (e.g., graphics containing eyes that resemble the user's real eyes and/or that appear significantly different than the user's real eyes) and skin. The eyes may have a blink rate that tracks the user's measured actual blink rate. The user's blinks may be detected using an inwardly facing camera or other user monitoring sensor. The skin color that is displayed on display 24 may match the actual skin color of the user's face. If desired, the user's skin color may be captured with a camera in device 10 (or in another electronic device), measured with a color-sensitive light sensor, and/or may be determined based on user input. If desired, the computer-generated (control-circuitry-generated) eyes may have a computer-generated point-of-gaze that matches the user's measured point-of-gaze. The point-of-gaze may be measured using a gaze detection system in device 10. Other eye attributes may also be replicated such as pupil size or eye color. If desired, the eyes displayed on display 24 may have attributes that do not match the attributes of the user's eyes. For example, blink events, point-of-gaze, pupil size, eye color, and/or other eye attributes may be different for the computer-generated version of the eyes on display 24 than for the user's actual eyes.

Control circuitry 16C may adaptively adjust the skin color that is displayed on display 24 based on the color of ambient light measured with ambient light sensor 32 and/or one or more additional sensors in electronic device 10. As the color of ambient light in the environment surrounding device 10 changes, control circuitry 16C may adaptively adjust the skin color that is displayed on display 24 to account for the chromatic adaptation of the human visual system to different illuminants. For example, control circuitry 16C may adaptively adjust the white point of display 24 based on the color of ambient light to make sure that the skin tone on display 24 is perceived to be consistent in both warm and cool ambient lighting environments.

Outer display 24 may be configured to display different types of content depending on the display mode in which inner display 14 is operating. For example, in passthrough mode, captured camera images of the surrounding environment are displayed on inner display 14 without overlaid virtual display content. To inform nearby people that the user is viewing the surrounding environment on display 14, display 24 may be configured to display the user's face and eyes when device 10 is operating in passthrough mode. In mixed reality mode, both passthrough display content (captured camera images of the surrounding environment) and overlaid virtual image content may be displayed on display 14. To inform nearby people that the user is viewing the surrounding environment but is also viewing virtual image content, display 24 may be configured to display the user's face and eyes under an overlaid abstract layer (e.g., abstract shapes, colors, patterns, and/or other visual content without text or recognizable objects) when device 10 is operating in mixed reality mode. In virtual reality mode, the user is fully immersed in virtual image content on display 14 and is viewing little to no passthrough image content associated with the surrounding environment. To inform nearby people that the user is immersed in virtual reality content and is not attentive to the surrounding environment, display 24 may be used to display an abstract layer (without any face or eyes) when device 10 is operating in virtual reality mode.

If desired, control circuitry 16C may adapt the face layer on outer display 24 to the color of ambient light measured by sensor 32 without adapting the abstract layer on outer display 24 to the color of ambient light. This is merely illustrative, however. If desired, both the abstract layer and the face layer on outer display 24 may be adapted to the measured color of ambient light.

User input and other information may be gathered using sensors and other input devices in the input-output devices of device 10. If desired, device 10 may include haptic output devices (e.g., vibrating components overlapped by a display, portions of a housing wall, and/or other device structures), light-emitting diodes and other light sources, speakers such as ear speakers for producing audio output, and other electrical components used for input and output. If desired, device 10 may include circuits for receiving wireless power, circuits for transmitting power wirelessly to other devices, batteries and other energy storage devices (e.g., capacitors), joysticks, buttons, and/or other components.

Some or all of housing 12 may serve as support structures (see, e.g., the portion of housing 12 formed by support structures 12T and the portion of housing 12 formed from support structures 12M and 12I). In configurations in which electronic device 10 is a head-mounted device (e.g., a pair of glasses, goggles, a helmet, a hat, etc.), structures 12T and 12M and/or other portions of housing 12 may serve as head-mounted support structures (e.g., structures forming a helmet housing, head straps, temples in a pair of eyeglasses, goggle housing structures, and/or other head-mounted structures). The head-mounted support structures may be configured to be worn on a head of a user during operation of device 10 and may support display(s), lenses, sensors, other input-output devices, control circuitry, and/or other components.

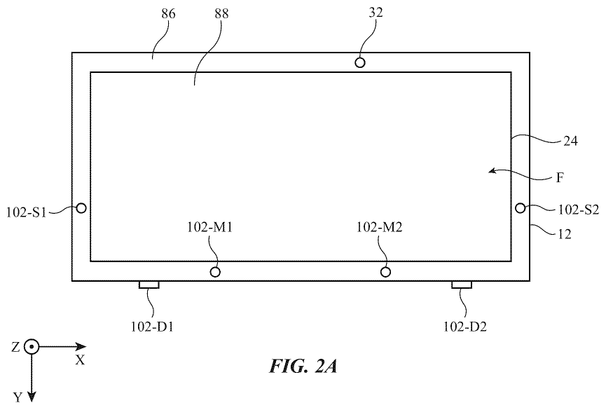

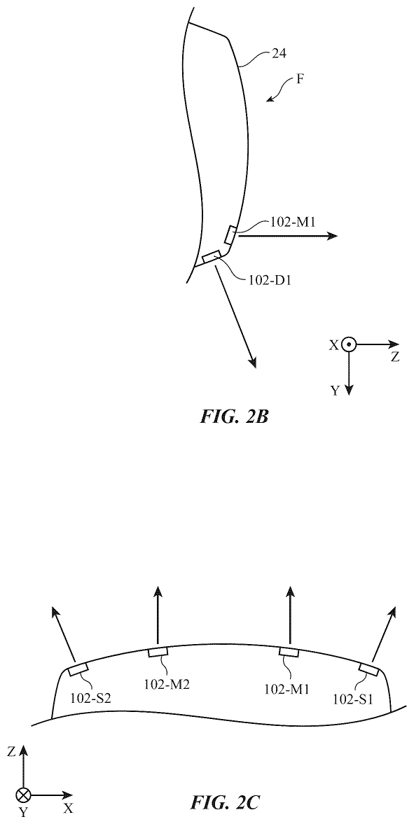

FIG. 2A is a front view of device 10 in an illustrative configuration in which front facing display 24 has been formed over most of front face F of housing 12. Sensors such as ambient light sensor 32, main cameras 102-M1 and 102-M2, downward-facing cameras 102-D1 and 102-D2, and side-facing cameras 102-S1 and 102-S2 may be formed along one or more portions of the peripheral edge of housing 12 on front face F.

Display 24 may include an array of display pixels formed from liquid crystal display (LCD) components, an array of electrophoretic pixels, an array of plasma pixels, an array of organic light-emitting diode pixels or other light-emitting diodes, an array of electrowetting pixels, or pixels based on other display technologies. The array of pixels of display 24 forms an active area 88. Active area 88 may be used to display images. Active area 88 may be rectangular, may have a non-rectangular shape (e.g., a shape of a pair of goggles), or may have other suitable shapes. Inactive border area 86 may run along one or more edges of active area 88. Inactive border area 86 may contain circuits, signal lines, and other structures that do not emit light for forming images. Sensors such as ambient light sensor 32, flicker sensors, infrared sensors, cameras (e.g., main cameras 102-M1 and 102-M2, downward-facing cameras 102-D1 and 102-D2, and side-facing cameras 102-S1 and 102-S2, etc.), depth sensors, and/or other sensors may be mounted in inactive border area 86 on front face F, if desired.

Main cameras 102-M1 and 102-M2, downward-facing cameras 102-D1 and 102-D2, and side-facing cameras 102-S1 and 102-S2 may capture images that are used in combination with data from ambient light sensor 32 to determine the luminance and chromaticity of ambient light in a physical environment around device 10. Ambient light sensor 32 may have an associated field of view. Using cameras 102-M1, 102-M2, 102-D1, 102-D2, 102-S1, and/or 102-S2 in addition to ambient light sensor 32 to determine the ambient light luminance and chromaticity for a physical environment may allow ambient light outside the field of view of ambient light sensor 32 to be accounted for in the ambient light measurements. The ambient light conditions determined using ambient light sensor 32 and cameras 102-M1, 102-M2, 102-D1, 102-D2, 102-S1, and/or 102-S2 may be used to adjust the skin color that is displayed on display 24.

To hide inactive circuitry (e.g., circuitry that does not include pixels for displaying images), sensors, and other components in border area 86 from view, the underside of a cover layer that covers display 24 (e.g., a cover glass layer, a tinted cover layer, or other cover layer on front face F) may be coated with an opaque masking material such as a layer of black ink. To accommodate optical components (e.g., a camera, a light-based proximity sensor, an ambient light sensor, status indicator light-emitting diodes, camera flash light-emitting diodes, etc.) that are mounted under inactive border area 86, one or more openings (sometimes referred to as windows) may be formed in the opaque masking layer of inactive region 86. For example, one or more a light component windows may be formed in a peripheral portion of display 24 in inactive border area 86. Each light component window may cover at least one of sensor 32 and cameras 102-M1, 102-M2, 102-D1, 102-D2, 102-S1, and 102-S2 may include ink having a higher transmission than the surrounding ink in inactive border 86 so that ambient light can reach sensor 32 and cameras 102-M1, 102-M2, 102-D1, 102-D2, 102-S1, and/or 102-S2 while sensor 32 and cameras 102-M1, 102-M2, 102-D1, 102-D2, 102-S1, and/or 102-S2 remain obscured by the ink.

Each one of cameras 102-M1, 102-M2, 102-D1, 102-D2, 102-S1, and 102-S2 may be a color camera (e.g., configured to sense multiple colors of visible light such as red, green, and blue) or a monochrome camera. As one example, cameras 102-M1 and 102-M2 may be color cameras whereas cameras 102-D1, 102-D2, 102-S1, and 102-S2 may be monochrome cameras.

Each one of cameras 102-M1, 102-M2, 102-D1, 102-D2, 102-S1, and 102-S2 may have a unique field of view. Each camera may be characterized as pointing in a direction that is centered within the field of view. As shown in the side view of FIG. 2B, main cameras 102-M1 and 102-M2 may point approximately parallel to the Z-axis to capture images of the area immediately in front of device 10. Downward-facing cameras 102-D1 and 102-D2, meanwhile, may point substantially in the negative Y-direction and may, as an example, capture images of a user's hands while a user wears device 10. The directions associated with cameras 102-M1 and 102-D1 may differ by at least 30 degrees within the YZ-plane, at least 45 degrees within the YZ-plane, at least 60 degrees within the YZ-plane, etc.

As shown in the top view of FIG. 2C, side-facing cameras 102-S2 may point in directions that are non-parallel with the Z-axis in order to capture images of a greater portion of the physical environment surrounding device 10. As an example, side-facing camera 102-S1 may point at a 45 degree angle in the negative X-direction relative to the Z-axis whereas side-facing camera 102-S1 may point at a 45 degree angle in the positive X-direction relative to the Z-axis. The directions associated with cameras 102-M1 and 102-S1 may differ by at least 20 degrees within the XZ-plane, at least 30 degrees within the XZ-plane, at least 45 degrees within the XZ-plane, at least 60 degrees within the XZ-plane, etc. The directions associated with cameras 102-M2 and 102-S2 may differ by at least 20 degrees within the XZ-plane, at least 30 degrees within the XZ-plane, at least 45 degrees within the XZ-plane, at least 60 degrees within the XZ-plane, etc. The directions associated with cameras 102-M1 and 102-M2 may be approximately parallel (e.g., within 10 degrees, within 5 degrees, within 3 degrees, etc.).

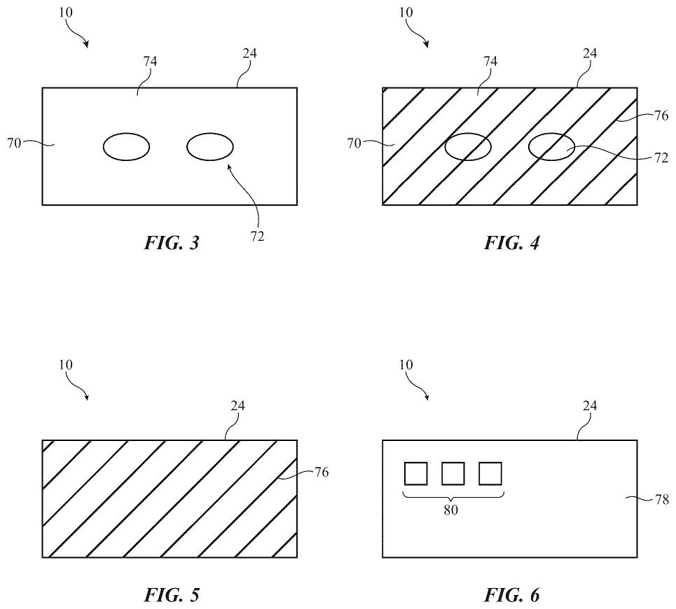

As a user wears device 10 and views display content on inner display 14, outer display 24 may be used to inform nearby people of the status of device 10 and/or the status of the user wearing device 10. For example, display content on display 24 may be adjusted based on the operating mode of device 10 and/or the display mode of inner display 14. FIGS. 3, 4, 5, and 6 are front views of display 24 showing illustrative types of display content that may be displayed on outer display 24 during different operating modes of device 10 (e.g., during different display modes associated with inner display 14).

In the example of FIG. 3, device 10 and inner display 14 are operating in passthrough mode. In passthrough mode, captured images of the user's environment are displayed on inner display 14 with minimal or no overlaid virtual image content. The user is therefore able to view the real-world environment on display 14 without any virtual distractions. In this type of scenario, outer display 24 may be used to display face layer 70 to let nearby people know that the user is aware of the real-world environment. In passthrough mode, face layer 70 may be displayed on display 24 with minimal or no overlaid image content. Face layer 70 may include camera-captured and/or computer-generated facial features such as skin 74 and eyes 72. Eyes 72 may track the user's gaze so that eyes 72 have a point-of-gaze that matches the actual user's point-of-gaze as the user views passthrough content on inner display 14. The color of skin 74 of face layer 70 may be based on user input or may be based on gathered sensor data (e.g., the user's skin color may be captured using an inward-facing camera or other sensor in device 10, using a camera in an external electronic device, using a color light sensor, and/or using other suitable sensors and/or user input). The skin color may be detected/determined during a dedicated enrollment process or may be gathered during normal use of device 10.

In passthrough mode, control circuitry 16C may adjust the color of skin 74 on outer display 24 based on the color of ambient light measured by ambient light sensor 32 to ensure that the skin color is perceived to be consistent under different illuminants. This may include, for example, adaptively adjusting the white point of face layer 70 to be colder (e.g., bluer) under cool ambient light illumination and to be warmer (e.g., redder) under warm ambient light illumination.

A user's skin tone may be captured by a camera (e.g., an inward-facing camera in device 10, a forward-facing camera in device 10, a camera that is part of another electronic device, etc.). In particular, a face image (e.g., a captured image of the user's face) may have forehead regions and cheek regions from which an aggregate skin color can be extracted. The skin color may be represented in any suitable color space. In some arrangements, the skin color may be represented in a perceptually uniform color space such as Lab color space or Yu′v′ color space.

In the example of FIG. 4, device 10 and inner display 14 are operating in mixed reality mode. In mixed reality mode, captured images of the user's environment are displayed on inner display 14, and virtual image content such as computer-generated virtual display elements are overlaid onto (e.g., layered with) the passthrough content. The user is therefore able to view the real-world environment on display 14 but may not be fully attentive to the real-world surroundings due to the presence of virtual content on display 14. In this type of scenario, outer display 24 may be used to display face layer 70 to let nearby people know that the user is aware of the real-world environment, and an additional layer such as abstract layer 76 may be overlaid onto (e.g., layered with) face layer 70. Abstract layer 76 may include abstract colors, shapes, patterns, content that is free of recognizable objects or text, and/or other display content.

In mixed reality mode, control circuitry 16C may adjust the color of skin 74 on outer display 24 based on the color of ambient light measured by ambient light sensor 32 to ensure that the skin color is perceived to be consistent under different illuminants. This may include, for example, adaptively adjusting the white point of face layer 70 to be colder (e.g., bluer) under cool ambient light illumination and to be warmer (e.g., redder) under warm ambient light illumination.

If desired, control circuitry 16C may adapt face layer 70 to the color of ambient light without adapting abstract layer 76 to the color of ambient light. For example, face layer 70 may have an adjustable white point that shifts with the color of ambient light (thereby allowing skin 74 and eyes 72 to be perceived as consistent under different illuminants), while abstract layer 76 may have a fixed white point that remains constant under different illuminants. While the white point of abstract layer 76 may remain fixed, the brightness of abstract layer 76 may be adjusted to adapt to the measured brightness of ambient light. This is merely illustrative, however. If desired, control circuitry 16C may adaptively adjust the white point of abstract layer 76 based on the color of ambient light.

In the example of FIG. 5, device 10 and inner display 14 are operating in virtual reality mode. In virtual reality mode, most or all of the display content on display 14 is virtual content and/or other content that does not represent the user's current real-world environment. The user is fully immersed in a virtual world that is displayed on display 14 and is not attentive to the people or objects in the user's real-world environment. In this type of scenario, outer display 24 may be used to display abstract layer 76 to let nearby people know that the user is not aware of and/or cannot see the real-world environment. Abstract layer 76 may include abstract colors, shapes, patterns, content that is free of recognizable objects or text, and/or other display content. In virtual reality mode, abstract layer 76 may be displayed on display 24 with minimal or no overlaid image content (e.g., without face layer 70).

In virtual reality mode, abstract layer 76 may have a fixed white point that remains constant under different illuminant colors. This is merely illustrative, however. If desired, control circuitry 16C may adaptively adjust the white point of abstract layer 76 based on the color of ambient light when device 10 is operating in virtual reality mode.

In the example of FIG. 6, device 10 and inner display 14 are operating in an off state or a reboot state. For example, display 14 may be turned off, device 10 may be resting on a table or otherwise not on a user's head, and/or display 14 may be powering up after a reboot. In these and other scenarios, outer display 24 may be used to display user interface layer 78. User interface layer 78 may include user interface elements 80 (e.g., low battery icons, charging status icons, pairing status information, menu buttons, user-selectable on-screen options, user login information, authentication options, etc.).

User interface layer 78 may have a fixed white point that remains constant under different illuminant colors. This is merely illustrative, however. If desired, control circuitry 16C may adaptively adjust the white point of user interface layer 78 based on the color of ambient light.

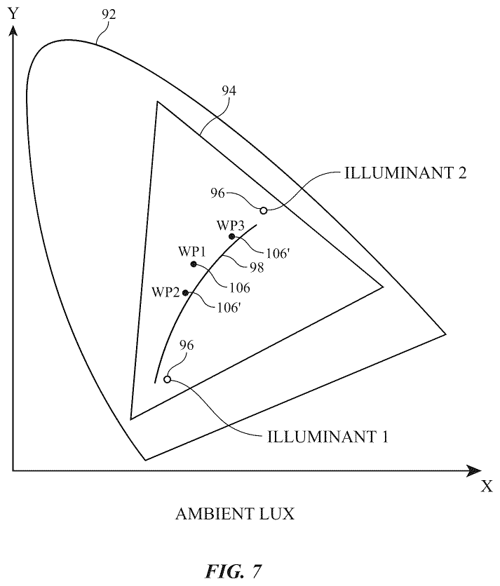

A chromaticity diagram illustrating how display 24 may have an adaptive white point that is determined at least partly based on ambient lighting conditions is shown in FIG. 7. The chromaticity diagram of FIG. 7 illustrates a two-dimensional projection of a three-dimensional color space (sometimes referred to as the 1931 CIE chromaticity diagram). The color generated by a display such as display 24 may be represented by chromaticity values x and y. The chromaticity values may be computed by transforming, for example, three color intensities (e.g., intensities of colored light emitted by a display) such as intensities of red, green, and blue light into three tristimulus values X, Y, and Z and normalizing the first two tristimulus values X and Y (e.g., by computing x=X/(X+Y+Z) and y=Y/(X+Y+Z) to obtain normalized x and y values). Transforming color intensities into tristimulus values may be performed using transformations defined by the International Commission on Illumination (CIE) or using any other suitable color transformation for computing tristimulus values.

Any color generated by a display may therefore be represented by a point (e.g., by chromaticity values x and y) on a chromaticity diagram such as the diagram shown in FIG. 7. Bounded region 92 of FIG. 7 represents the limits of visible light that may be perceived by humans (i.e., the total available color space). The colors that may be generated by a display are contained within a subregion of bounded region 92. For example, bounded region 94 may represent the available color space for display 24 (sometimes referred to as the color gamut of display 24).

Display 24 may be characterized by various calibration settings such as gamma and color temperature. The color temperature of display 24 determines the color cast of display 24. Although the color temperature setting of a display can affect the appearance of all colors, the color temperature setting of a display is sometimes referred to as the “white point” of the display because it is defined by the white color produced when all of the pixels in a display are operated at full power (e.g., when R=G=B=255). The white point of display 24 may be defined by an illuminant (e.g., D65, D50, or other illuminant), a color temperature (e.g., 6500 degrees Kelvin (K), 5000 K, or other color temperature), or a set of chromaticity coordinates. The color temperature of a light source refers to the temperature at which a theoretical black body radiator would emit radiation of a color most closely resembling that of the light source. Curve 98 illustrates the range of colors that would radiate from an ideal black body at different color temperatures and is sometimes referred to as the Planckian locus or black body locus. The color temperatures on black body curve 98 range from higher temperatures on the left (e.g., near the cooler hues around illuminant 1) to lower temperatures on the right (e.g., near the warmer hues around illuminant 2).

Control circuitry 16C may operate all or some of display 24 in an ambient-adaptive mode or a non-adaptive mode, if desired. As discussed in connection with FIGS. 3-6, ambient-adaptive adjustments may be made to some layers being displayed on display 24 without being applied to other layers that are displayed on display 24. For example, control circuitry 16C may adaptively adjust the white point of face layer 70 based on the color of ambient light, whereas the white point of abstract layer 76 and/or user interface layer 78 may remain fixed at a default white point (or may be adapted to ambient light using less aggressive strength values when compared to face layer 70). In mixed reality mode when abstract layer 76 is overlaid onto face layer 70 (see, e.g., FIG. 4), the white point of face layer 70 may be adjusted based on the ambient light color measured by sensor 32 (e.g., to adapted white point WP2 or WP3), while the white point of abstract layer 76 may remain fixed (e.g., at a default white point such as WP1). Control circuitry 16C may switch between ambient-adaptive mode and non-adaptive mode, may adjust the strength value which determines how aggressively the white point should match the measured ambient light color, and/or may adjust which layers on display 24 have an adaptive or fixed white point (e.g., based on sensor data, application information, display content, display mode, user input, settings, etc.).

The default white point 106 (WP1) of a given layer on display 24 (e.g., face layer 70, abstract layer 76, user interface layer 78, etc.) may be any suitable white point. For example, white point WP1 may be D65, D50, or any other suitable white color. If desired, white point WP1 may be selected and/or adjusted by the user. When a given layer on display 24 is not adapted to the color of ambient light, the white point of that layer on display 24 (e.g., the white point of an individual layer on display 24 such as abstract layer 76 and/or user interface layer 78) may remain fixed at WP1 even as the ambient lighting conditions change.

When a given layer on display 24 is adapted to the color of ambient light, control circuitry 16C may dynamically adjust the white point of that layer on display 24 (e.g., the white point of an individual layer on display 24 such as face layer 70) based on the color of ambient light. There may be certain ambient lighting situations where the default white point WP1 is appropriate. For example, when ambient light is neither overly cool nor overly warm, default white point WP1 may be a close match to the ambient light and may therefore be agreeable to viewers that are viewing display 24. However, under other ambient lighting conditions (e.g., under different illuminants such as illuminants 96 of FIG. 7), control circuitry 16C may adjust the white point of face layer 70 on display 24 to an ambient-adaptive white point (e.g., one of ambient-adaptive white points 106′ of FIG. 7).

For example, under a first ambient illuminant 96 such as illuminant 1, control circuitry 16C may adjust the white point of face layer 70 on display 24 to ambient-adapted white point WP2 (represented by one of points 106′). Ambient-adapted white point WP2 more closely matches the color of illuminant 1 than default white point WP1. Under a second ambient illuminant 96 such as illuminant 2, control circuitry 16C may adjust the white point of face layer 70 on display 24 to ambient-adapted white point WP3 (represented by another one of points 106′). Ambient-adapted white point WP3 more closely matches the color of illuminant 2 than default white point WP1.

By adjusting the white point of face layer 70 on display 24 based on the color of ambient light, the color cast of skin 74 of face layer 70 will adapt to the different ambient lighting conditions just as the viewer's vision chromatically adapts to different ambient lighting conditions. For example, illuminant 2 may correspond to an indoor light source having a warm hue, whereas illuminant 1 may correspond to daylight or an indoor light source having a cool hue. Illuminant 2 may have a lower color temperature than illuminant 1 and may therefore emit warmer light. In warmer ambient light (e.g., under illuminant 2), control circuitry 16C can adjust the white point of face layer 70 on display 24 to ambient-adapted white point WP3, which in turn adjusts the color cast of skin 74 of face layer 70 to a warmer hue (i.e., light with a lower color temperature) than that which would be produced if the default white point WP1 were maintained as the display white point. This adaptive adjustment of face layer 70 ensures that skin tone 74 displayed on display 24 is perceived to be consistent under different ambient lighting conditions.

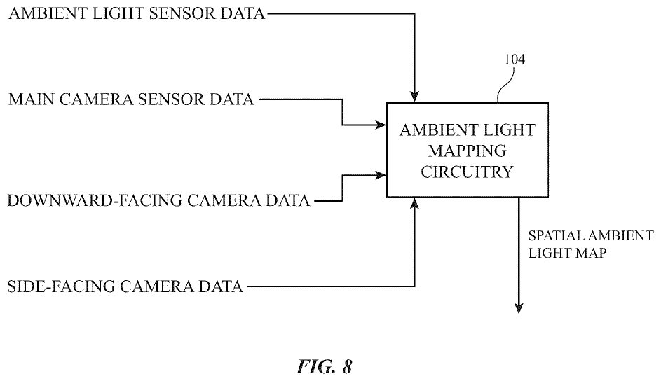

To improve the consistency of the perceived appearance of skin tone 74 under different ambient light conditions, ambient light mapping circuitry may be used to generate a spatial ambient light map that characterizes ambient light luminance and chromaticity as a function of position relative to device 10. FIG. 8 is a diagram showing an example of this type. As shown in FIG. 8, ambient light mapping circuitry 104 may be used to output a spatial ambient light map using data from one or more sensors. In particular, ambient light mapping circuitry 104 may receive data from ambient light sensor 32, data from main cameras 102-M1 and 102-M2, data from downward-facing cameras 102-D1 and 102-D2, and data from side-facing cameras 102-S1 and 102-S2. Ambient light mapping circuitry 104 may be a part of control circuitry 16C, as an example.

As one example, ambient light mapping circuitry 104 may be a trained model (sometimes referred to as machine learning model 104). The trained model may be a supervised learning model, an unsupervised learning model, or a semi-supervised learning model. The trained model may include a neural network such as a fully connected neural network, an artificial neural network, a convolution neural network, a recurrent neural network, a modular neural network, a feedforward neural network, and/or any other type of neural network. In general, any desired machine learning techniques (e.g., perceptron, naive Bayes, decision tree, logistic regression, K-nearest neighbor, support vector machine, etc.) may be used by the trained model.

The trained model may be trained by capturing ambient light in a variety of settings with both device 10 (e.g., using ALS 32 and cameras 102-M1, 102-M2, 102-D1, 102-D2, 102-S1, and 102-S2) and using an external camera (e.g., a high-performance camera that is separate from device 10). The data from the external camera may be treated as the ground truth that is used to train the model.

The example of using a trained model for ambient light mapping circuitry 104 is merely illustrative. In general, ambient light mapping circuitry may use any desired algorithm to output a spatial ambient light map using data from one or more sensors.

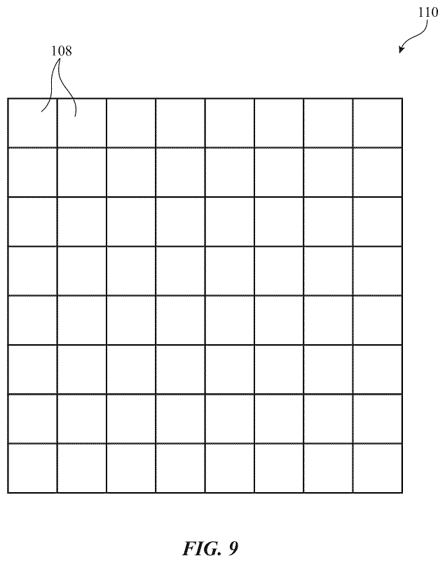

FIG. 9 shows a spatial ambient light map 110 that may be generated by ambient light mapping circuitry 104. As shown in FIG. 9, the spatial ambient light map 110 may include a plurality of pixels 108. Each pixel 108 may correspond to a location in the physical environment relative to device 10. Each pixel may have stored chromaticity and luminance values to characterize the ambient light in the corresponding location in the physical environment. As an example, each pixel 108 comprises X, Y, and Z values associated with an XYZ color space. The upper left pixel 108 in FIG. 9 may have associated chromaticity and luminance values that characterize the ambient light in an upper left position of the physical environment relative to device 10, the upper right pixel 108 in FIG. 9 may have associated chromaticity and luminance values that characterize the ambient light in an upper right position of the physical environment relative to device 10, the lower left pixel 108 in FIG. 9 may have associated chromaticity and luminance values that characterize the ambient light in a lower left position of the physical environment relative to device 10, etc.

In the example of FIG. 9, spatial ambient light map 110 has 8 rows of pixels and 8 columns of pixels (and therefore 64 total pixels). This example is merely illustrative. In general, spatial ambient light map 110 may have any desired number of pixels (e.g., less than 100, less than 75, less than 50, less than 25, etc.).

Main cameras 102-M1 and 102-M2 may perform signal processing on captured data. This signal processing may be inverted before providing the data to ambient light mapping circuitry 104 (so that ambient light mapping circuitry 104 receives the raw, unprocessed data from cameras 102-M1 and 102-M2).

Instead or in addition, the data from main cameras 102-M1 and 102-M2 may be downscaled before being provided to ambient light mapping circuitry 104. For example, each main camera may have hundreds or thousands of imaging pixels that capture luminance and chromaticity data. These captured images may be downscaled to an array of less than 100 pixels, less than 50 pixels, less than 25 pixels, etc. As an example, captured images from both main cameras 102-M1 and 102-M2 may be used to generate a single downscaled image with 4 rows of pixels and 6 columns of pixels (each pixel having associated luminance and chromaticity information). Control circuitry 16C may generate this single downscaled image and provide the downscaled image to ambient light mapping circuitry 104 or ambient light mapping circuitry 104 may optionally generate the single downscaled image itself.

In one example, ambient light mapping circuitry 104 may generate an initial version of the spatial ambient light map using only the single downscaled image from main cameras 102-M1/102-M2. The initial version of the spatial ambient light map may then be adjusted using data from ALS 32, cameras 102-D1/102-D2, and/or cameras 102-S1/102-S2. In one example, the data from cameras 102-D1, 102-D2, 102-S1, and 102-S2 may be used to obtain a single representative luminance value that is used for a global adjustment to the initial version of the spatial ambient light map. Control circuitry 16C may generate the single representative luminance value based on data from cameras 102-D1, 102-D2, 102-S1, and 102-S2 or ambient light mapping circuitry 104 may optionally generate the single representative luminance value itself.

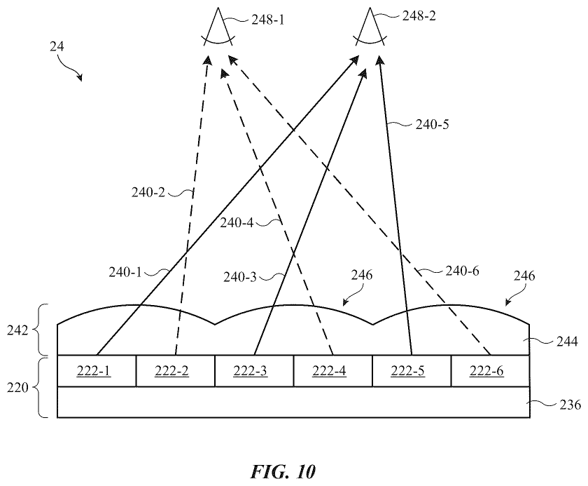

Display 24 may be a three-dimensional display such as a lenticular display. FIG. 10 is a cross-sectional side view of an illustrative lenticular display that may be incorporated into electronic device 10. Display 24 includes a display panel 220 with pixels 222 on substrate 236. Substrate 236 may be formed from glass, metal, plastic, ceramic, or other substrate materials and pixels 222 may be organic light-emitting diode pixels, liquid crystal display pixels, or any other desired type of pixels.

As shown in FIG. 10, lenticular lens film 242 may be formed over the display pixels. Lenticular lens film 242 (sometimes referred to as a light redirecting film, a lens film, etc.) includes lenses 246 and a base film portion 244 (e.g., a planar film portion to which lenses 246 are attached). Lenses 246 may be lenticular lenses that extend along respective longitudinal axes (e.g., axes that extend into the page parallel to the Y-axis). Lenses 246 may be referred to as lenticular elements 246, lenticular lenses 246, optical elements 246, etc.

The lenses 246 of the lenticular lens film cover the pixels of display 24. An example is shown in FIG. 10 with display pixels 222-1, 222-2, 222-3, 222-4, 222-5, and 222-6. In this example, display pixels 222-1 and 222-2 are covered by a first lenticular lens 246, display pixels 222-3 and 222-4 are covered by a second lenticular lens 246, and display pixels 222-5 and 222-6 are covered by a third lenticular lens 246. The lenticular lenses may redirect light from the display pixels to enable stereoscopic viewing of the display.

Consider the example of display 24 being viewed by a viewer with a first eye (e.g., a right eye) 248-1 and a second eye (e.g., a left eye) 248-2. Light from pixel 222-1 is directed by the lenticular lens film in direction 240-1 towards left eye 248-2, light from pixel 222-2 is directed by the lenticular lens film in direction 240-2 towards right eye 248-1, light from pixel 222-3 is directed by the lenticular lens film in direction 240-3 towards left eye 248-2, light from pixel 222-4 is directed by the lenticular lens film in direction 240-4 towards right eye 248-1, light from pixel 222-5 is directed by the lenticular lens film in direction 240-5 towards left eye 248-2, light from pixel 222-6 is directed by the lenticular lens film in direction 240-6 towards right eye 248-1. In this way, the viewer's right eye 248-1 receives images from pixels 222-2, 222-4, and 222-6, whereas left eye 248-2 receives images from pixels 222-1, 222-3, and 222-5. Pixels 222-2, 222-4, and 222-6 may be used to display a slightly different image than pixels 222-1, 222-3, and 222-5. Consequently, the viewer may perceive the received images as a single three-dimensional image.

Pixels of the same color may be covered by a respective lenticular lens 46. In one example, pixels 222-1 and 222-2 may be red pixels that emit red light, pixels 222-3 and 222-4 may be green pixels that emit green light, and pixels 222-5 and 222-6 may be blue pixels that emit blue light. This example is merely illustrative. In general, each lenticular lens may cover any desired number of pixels each having any desired color. The lenticular lens may cover a plurality of pixels having the same color, may cover a plurality of pixels each having different colors, may cover a plurality of pixels with some pixels being the same color and some pixels being different colors, etc.

In some arrangements, the stereoscopic display may have two or more optimal viewing positions (e.g., two or more viewing positions where the images from the display are perceived as three-dimensional). Indeed, the stereoscopic display images such that a viewer perceives three-dimensional images across a relatively wide range of viewing angles.

It should be understood that the lenticular lens shapes and directional arrows of FIG. 10 are merely illustrative. The actual rays of light from each pixel may follow more complicated paths (e.g., with redirection occurring due to refraction, total internal reflection, etc.). Additionally, light from each pixel may be emitted over a range of angles. The lenticular display may also have lenticular lenses of any desired shape or shapes. Each lenticular lens may have a width that covers two pixels, three pixels, four pixels, more than four pixels, more than ten pixels, etc. Each lenticular lens may have a length that extends across the entire display (e.g., parallel to columns of pixels in the display).

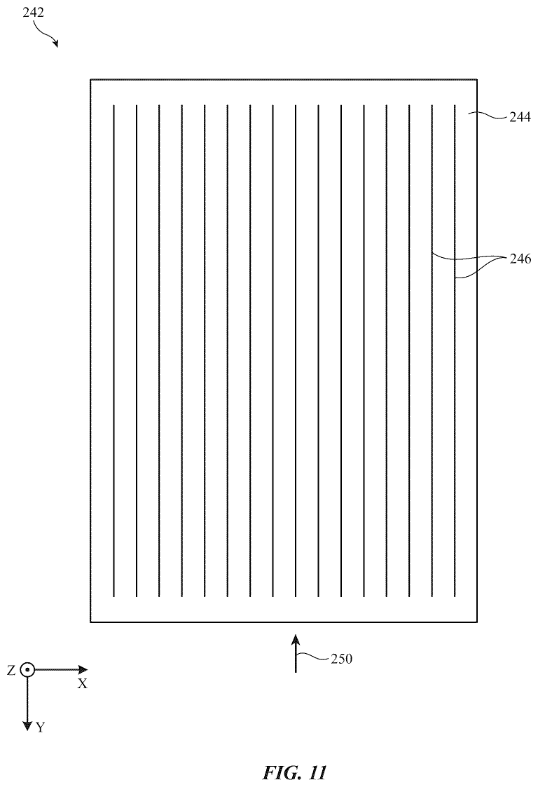

FIG. 11 is a top view of an illustrative lenticular lens film that may be incorporated into a lenticular display. As shown in FIG. 11, elongated lenses 246 extend across the display parallel to the Y-axis. For example, the cross-sectional side view of FIG. 3 may be taken looking in direction 250. The lenticular display may include any desired number of lenticular lenses 246 (e.g., more than 10, more than 100, more than 1,000, more than 10,000, etc.). In FIG. 11, the lenticular lenses extend perpendicular to the upper and lower edge of the display panel. This arrangement is merely illustrative, and the lenticular lenses may instead extend parallel to the X-axis or at a non-zero, non-perpendicular angle (e.g., diagonally) relative to the display panel if desired.

Three-dimensional display 24 may be capable of providing unique images at different viewing positions of display 24. Control circuitry 16C may control display 24 to display desired images at different viewing positions. There is much flexibility in how the display provides images to the different viewing positions. Display 24 may display entirely different content at different viewing positions of the display. For example, an image of a first object (e.g., a cube) is displayed for position 1, an image of a second, different object (e.g., a pyramid) is displayed for position 2, an image of a third, different object (e.g., a cylinder) is displayed for position 3, etc. This type of scheme may be used to allow different viewers to view entirely different scenes from the same display.

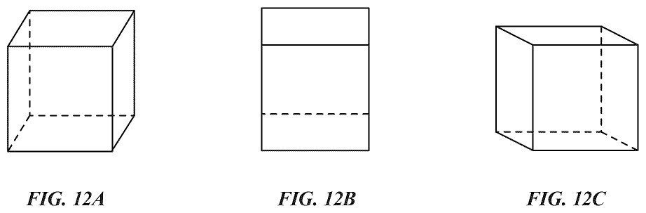

In another possible use-case, display 24 may display a similar image for each viewing position, with slight adjustments for perspective between each position. This may be referred to as displaying the same content at different perspectives, with one image corresponding to a unique perspective of the same content. For example, consider an example where the display is used to display a three-dimensional cube. The same content (e.g., the cube) may be displayed on all of the different positions in the display. However, the image of the cube provided to each viewing position may account for the viewing angle associated with that particular position. In a first position, for example, the viewing cone may be at a −10° angle relative to the surface normal of the display. Therefore, the image of the cube displayed for the first position may be from the perspective of a −10° angle relative to the surface normal of the cube (as in FIG. 12A). A second position, in contrast, is at approximately the surface normal of the display. Therefore, the image of the cube displayed for the second position may be from the perspective of a 0° angle relative to the surface normal of the cube (as in FIG. 12B). A third position may be at a 10° angle relative to the surface normal of the display. Therefore, the image of the cube displayed for the third position may be from the perspective of a 10° angle relative to the surface normal of the cube (as in FIG. 12C). As a viewer progresses from the first position to the third position in order, the appearance of the cube gradually changes to simulate looking at a real-world object. Three-dimensional display 24 may use this type of technique to display images of a user's face that, as a viewer progresses through different viewing angles, gradually change to simulate looking at a real-world face.

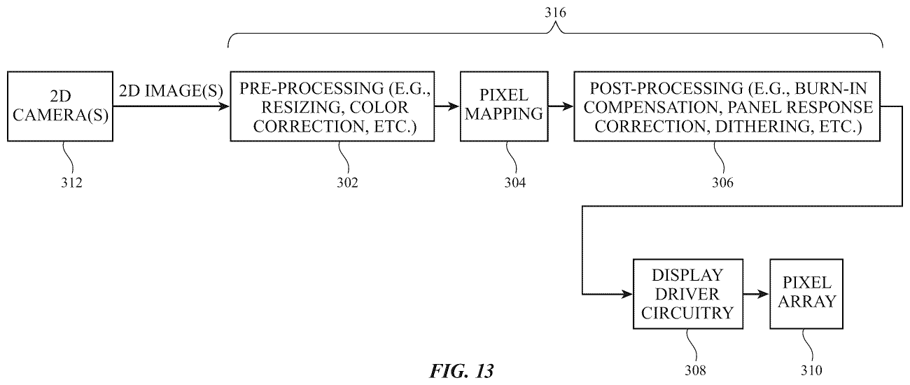

FIG. 13 is a schematic diagram of display pipeline circuitry within electronic device 10. As shown in FIG. 13, electronic device 10 may include a pre-processing block 302, a pixel mapping block 304, and a post-processing block 306. Pre-processing block 302, pixel mapping block 304, and post-processing block 306 may sometimes collectively be referred to as display pipeline circuitry 316.

Pre-processing block 302 (sometimes referred to as pre-processing circuitry 302) may receive one or more two-dimensional (2D) images as an input. In one illustrative example shown in FIG. 13, the 2D image(s) may be received by pre-processing block 302 from a two-dimensional camera 312. The two-dimensional camera 312 may be, as an example, an inward-facing camera such as inward-facing camera 102-I in FIG. 1 that is configured to capture images of a user's face while device 10 is worn by a user. The pre-processing performed by block 302 may include a wide variety of processing of the 2D image. The pre-processing may change the brightness level of one or more pixels within the 2D image.

Pre-processing circuitry 302 may be used to adjust each two-dimensional image to improve sharpness and mitigate aliasing. Once the two-dimensional image is ultimately displayed on pixel array 310 for viewing, the lenticular lenses in the display anisotropically magnify the image. In the example of FIG. 11, the lenticular lenses magnify light in the X-dimension while not magnifying the light in the Y-dimension. This example is merely illustrative and the lenticular lenses may alternatively magnify light in the Y-dimension while not magnifying the light in the X-dimension or may magnify light in both the X-dimension and the Y-dimension. In any of these arrangements, the magnification may be greater in one dimension than another (e.g., greater in the X-dimension than the Y-dimension or vice versa). This anisotropic magnification may cause aliasing in the image perceived by the user.

Pre-processing circuitry 302 may apply an anisotropic low-pass filter to the two-dimensional image. This mitigates aliasing when the pre-processed image is displayed and perceived by a viewer. As another option, the content may be resized by pre-processing circuitry 302. In other words, pre-processing circuitry 302 may change the aspect ratio of the two-dimensional image for a given view (e.g., by shrinking the image in the X-direction that is effected by the lenticular lenses). Anisotropic resizing of this type mitigates aliasing when the pre-processed image is displayed and perceived by the viewer.

Pre-processing may also include various color operations such as tone mapping (e.g., selecting a content-luminance to display-luminance mapping), adjusting color based ambient light level and/or ambient light color (e.g., using ambient light information received by ambient light sensor 32 and one or more cameras 102 in device 10), adjusting color based on brightness settings, saturation adjustment, etc.

Pixel mapping block 304 may use a three-dimensional image (e.g., captured by an inward-facing three-dimensional camera that captures images of a user's face while device 10 is worn by a user) to map the two-dimensional image that is intended to be displayed on display 14 (e.g., the 2D image received from pre-processing block 302) to the pixel array of display 24. For every sub-pixel of the display, pixel mapping circuitry 304 obtains a corresponding color value from the two-dimensional image that is intended to be displayed on display 24. The output of pixel mapping block 304 may be referred to as a three-dimensional (3D) image. The 3D image presents the content (e.g., the user's face) from different perspectives at multiple views.

After pixel mapping is performed, the array of brightness values for the pixel array may undergo post-processing at block 306. The post-processing may include border masking (e.g., imparting a desired shape to the light-emitting area of the display such as a rectangular shape with rounded corners), burn-in compensation (e.g., compensating the pixel data to mitigate risk of burn-in and/or mitigate visible artifacts caused by burn-in), panel response correction (e.g., mapping luminance levels for each pixel to voltage levels using a gamma curve), color compensation (e.g., using a color lookup table), dithering (e.g., randomly adding noise to the luminance values to reduce distortion when the image is ultimately displayed by the pixel array, manipulated by the lenticular lenses, and viewed by the viewer), etc.

After post-processing is complete, target pixel voltages for each pixel in display 24 may be provided to display driver circuitry 308. Display driver circuitry 308 provides the target pixel voltages to pixel array 310 using data lines. The images are then displayed on display 24.

Pre-processing block 302 is performed before pixel mapping and therefore may sometimes be referred to as pre-mapping block 302, pre-mapping circuitry 302, pre-mapping-processing block 302, pre-mapping-processing circuitry 302, etc. Post-processing block 306 is performed after pixel mapping and therefore may sometimes be referred to as post-mapping block 306, post-mapping circuitry 306, post-mapping-processing block 306, post-mapping-processing circuitry 306, etc.

Pixel mapping circuitry 304 may perform the pixel mapping operations for each display frame (e.g., at a frequency that is equal to the display frame rate). Similarly, pre-processing 302 and post-processing 306 may be performed at a frequency that is equal to the display frame rate.

The content displayed on three-dimensional display 24 may be based on ambient light map 110 generated by ambient light mapping circuitry 104. There are numerous ways in which spatial ambient light map 110 may be used to generate and/or adjust content for display 14 and/or 24.

As one example, 2D camera(s) 312 may capture one or more enrollment images of a user's face. The enrollment may include images of the user's face that are captured from different directions. The enrollment image(s) may include a first image captured from an upper viewing angle (e.g., looking straight ahead and down at the user's face), a second image captured from a left viewing angle (e.g., looking at the right side of the user's face from an even height with the user's face), a third image captured from a right viewing angle (e.g., looking at the left side of the user's face from an even height with the user's face), and a lower viewing angle (e.g., looking straight ahead and up at the user's face). In each one of these four images, the dominant ambient lighting source may be aligned with the camera/viewing angle. These enrollment images may be, as an example, captured with one or more high-resolution cameras such as main cameras 102-M1 and 102-M2 while device 10 is not worn by the user. During operation of device 10, the enrollment images may be used in combination with real time images of the user's face captured by one or more inward-facing cameras in device 10. The inward-facing camera used to capture the real time images of the user's face (e.g., camera 102-I) may have a lower resolution than the camera used to capture the enrollment images. The enrollment images may therefore be combined to provide a high resolution image of the user's face. The high resolution image of the user's face may be modified based on the real time images of the user's face to represent the user's real time facial expression.

In this example of using enrollment images to generate a single two-dimensional image for display on display 24, pre-processing block 302 may combine the enrollment images using a weighted average (e.g., using weighting coefficients). Ambient light mapping circuitry 104 may use the spatial ambient light map to generate the weighting coefficients that are used to combine the enrollment images according to the weighted average. As examples, when the spatial ambient light map indicates that the ambient light is primarily above device 10, the enrollment image from the upper viewing angle may have a higher coefficient than the remaining enrollment images (e.g., 0.7, 0.1, 0.1, 0.1 for the upper, left, right, and lower enrollment images respectively). At a subsequent time, when the spatial ambient light map indicates that the ambient light is primarily to the right of device 10, the enrollment image from the right viewing angle may have a higher coefficient than the remaining enrollment images (e.g., 0.2, 0.2, 0.4, 0.2 for the upper, left, right, and lower enrollment images respectively).

The spatial ambient light map may therefore be used to generate coefficients that dictate the weights for a weighted average of multiple enrollment images during pre-processing block 302. Additional pre-processing may be performed on the resulting two-dimensional image before pixel mapping.

Ambient light mapping circuitry 104 may generate a color correction matrix in addition to the weighting coefficients. The color correction matrix may be used to, for example, adjust the white point of skin 74 on display 24 (similar to as described in connection with FIG. 7) or other desired content on display 24. The color correction may be applied globally to the content on display 24 and/or may be applied only to skin 74 such that the that the skin tone on display 24 is perceived to be consistent in varying ambient lighting environments (e.g., both cool and warm ambient lighting).

In the example of using the spatial ambient light map to combine enrollment images using weighting coefficients and color correction factors during pre-processing block 302, the two-dimensional image ultimately provided to pixel mapping block 304 is viewing angle independent. In other words, the color adjustments/weightings are applied uniformly to the image before pixel mapping such that, after pixel mapping, the content will have the same appearance regardless of the viewing angle. This example is merely illustrative.

If desired, viewing angle dependent adjustments may be made during pixel mapping block 304 and/or post-processing block 306. An approximate viewing angle may be associated with each pixel in display 24. In other words, the geometry of the lenticular lens film over display 24 may cause a given pixel to emit light in a given direction. The given direction has an associated viewing angle. The viewing angle for each pixel may be stored in memory in control circuitry 16C, as one example. During pixel mapping or post-processing, color correction may be performed on a given pixel as a function of the viewing angle associated with that pixel, the spatial ambient light map generated by ambient light mapping circuitry 104, one or more color correction values generated by ambient light mapping circuitry 104, and/or any other desired factors.

The foregoing is merely illustrative and various modifications can be made to the described embodiments. The foregoing embodiments may be implemented individually or in any combination.

What is claimed is:

1. A head-mounted device, comprising:
a housing;
an outward-facing ambient light sensor coupled to the housing;
at least one outward-facing color camera coupled to the housing;
at least one outward-facing monochrome camera coupled to the housing;
at least one inward-facing display coupled to the housing; and
an outward-facing three-dimensional display coupled to the housing that is configured to display an image using a spatial ambient light map that is based on sensor data from the outward-facing ambient light sensor, the at least one outward-facing color camera, and the at least one outward-facing monochrome camera.

2. The head-mounted device defined in claim 1, wherein the spatial ambient light map has a plurality of pixels that spatially correlate to a physical environment of the head-mounted device.

3. The head-mounted device defined in claim 2, wherein each pixel in the plurality of pixels comprises X, Y, and Z values associated with an XYZ color space.

4. The head-mounted device defined in claim 2, wherein each pixel in the plurality of pixels comprises luminance and chromaticity information.

5. The head-mounted device defined in claim 1, wherein the at least one outward-facing color camera and the at least one outward-facing monochrome camera point in different directions.

6. The head-mounted device defined in claim 5, wherein the at least one outward-facing monochrome camera comprises first and second side-facing monochrome cameras and first and second downward-facing monochrome cameras.

7. The head-mounted device defined in claim 1, wherein the spatial ambient light map is generated using a trained model.

8. A method of operating a head-mounted device with a three-dimensional display, at least one inward-facing camera, at least one outward-facing camera, and an ambient light sensor, the method comprising:
obtaining one or more enrollment images of target content;
using the at least one outward-facing camera and the ambient light sensor, determining ambient light information;
using the at least one inward-facing camera, obtaining a real time image of the target content;
based on the one or more enrollment images of the target content, the ambient light information, and the real time image of the target content, generating an image of the target content; and
mapping the image to the three-dimensional display.

9. The method defined in claim 8, wherein the ambient light information comprises one or more weighting coefficients that are used to combine the one or more enrollment images of the target content in a weighted average while generating the image of the target content.

10. The method defined in claim 8, wherein determining the ambient light information comprises determining the ambient light information using a trained model.

11. The method defined in claim 10, wherein the at least one outward-facing camera comprises at least one monochrome camera and at least one color camera.

12. The method defined in claim 11, wherein the trained model is configured to determine the ambient light information using:
X, Y, and Z values associated with an XYZ color space from the ambient light sensor;
color data from the at least one color camera; and
a luminance value based on data from the at least one monochrome camera.

13. The method defined in claim 12, wherein the color data from the at least one color camera comprises a downscaled version of output from the at least one color camera.

14. The method defined in claim 12, wherein the color data from the at least one color camera comprises a signal-processing-inversed version of output from the at least one color camera.

15. The method defined in claim 8, wherein the at least one outward-facing camera comprises:
a first camera that points in a first direction; and
a second camera that points in a second direction that is separated from the first direction by at least 30 degrees.

16. A method of operating an electronic device with a three-dimensional display, a plurality of cameras, and an ambient light sensor, wherein each pixel in the three-dimensional display is configured to emit light in a given direction, the method comprising:
obtaining sensor data using the plurality of cameras and the ambient light sensor;
generating, based on the sensor data, an ambient light map that represents ambient light in a physical environment of the electronic device; and
displaying content on the three-dimensional display, wherein each pixel in the three-dimensional display is color corrected based on the ambient light map and the given direction associated with that pixel.

17. The method defined in claim 16, wherein the ambient light map has a plurality of pixels that spatially correlate to the physical environment.

18. The method defined in claim 17, wherein each pixel of the ambient light map comprises X, Y, and Z values associated with an XYZ color space.

19. The method defined in claim 17, wherein each pixel of the ambient light map comprises luminance and chromaticity information.

20. The method defined in claim 16, further comprising:
capturing an image of target content using an inward-facing camera of the electronic device, wherein the plurality of cameras is a plurality of outward-facing cameras, wherein the three-dimensional display is an outward-facing three-dimensional display, and wherein displaying the content on the three-dimensional display comprises displaying the target content on the three-dimensional display.
